(19) United States
(12) Patent Application Publication
(10) Pub. No.: US 2026/0366417 A1
(43) Pub. Date: Nov. 19, 2026

(54) LOGGING A WELLBORE PROFILE

(71) Applicant: Saudi Arabian Oil Company, Dhahran (SA)

(72) Inventors: Ida Bagus Gede Hermawan Manuaba, Dhahran (SA); Mugdad Alsaleh, Dammam (SA); Abdulrahman Alwadaey, Al Jubail (SA)

(21) Appl. No.: 19/206,277

(22) Filed: May 13, 2025

(51) Int. Cl. E21B 47/08; G01B 7/13

(52) U.S. Cl. CPC E21B 47/08; G01B 7/13

(57) ABSTRACT

A bottom hole assembly (BHA) includes a drill bit and a tool sub-assembly. The tool sub-assembly includes a housing; a pair of trackballs coupled to the tubular housing and adjustable between a retracted position within the housing and an extended position protruding from the housing to contact a wellbore during a drilling operation; and at least one control module configured adjust the pair of trackballs from the retracted position to the extended position to contact the wellbore during the drilling operation and, in response to the contact, detect movement of the pair of trackballs between the extended and retracted positions.

### TECHNICAL FIELD

This disclosure relates to systems and methods for logging a wellbore and, more particularly, logging a wellbore for at least one of size or profile.

### BACKGROUND

Conventional mechanical caliper logs are widely employed in the oil and gas industry for wellbore sizing and profiling, as well as tubular (e.g., pipeline, casing, tubing string) inspection and integrity assessment. These logs utilize a set of articulated arms or pads that mechanically measure the internal diameter of a wellbore or pipeline. Although highly useful, conventional mechanical caliper logs are limited in their ability to operate during drilling operations, as the caliper arms or pads cannot sustain the harsh drilling environment and risk becoming damaged or stuck.

### SUMMARY

In an example implementation, a downhole tool includes a tubular housing including a top sub-assembly configured to couple to or within a bottom hole assembly of a drilling assembly. The drilling assembly is configured to form a wellbore that extends from a terranean surface to a subterranean formation in a drilling operation. The downhole tool includes a first spherical member coupled to the tubular housing and adjustable between a retracted position within the tubular housing and an extended position protruding from the tubular housing to contact the wellbore during the drilling operation; a second spherical member coupled to the tubular housing radially offset from the first spherical member and adjustable between a retracted position within the tubular housing and an extended position protruding from the tubular housing to contact the wellbore during the drilling operation; and at least one control module configured to perform operations that include adjusting each of the first and second spherical members from the retracted position to the extended position; detecting movement of each of the first and second spherical members between the extended and retracted positions in response to contact between a surface of the wellbore and the first and second spherical members during the drilling operation; and outputting a signal representative of the detected movement to generate a profile of the wellbore relative to wellbore depth.

An aspect combinable with the example implementation includes a first biasing member coupled between the first spherical member and the at least one control module and a second biasing member coupled between the second spherical member and the at least one control module.

In another aspect combinable with one, some, or all of the previous aspects, each of the first and second biasing members is configured to urge the respective first and second spherical members from the retracted position to the extended position in response to a fluid signal provided to the at least one control module during the drilling operation.

In another aspect combinable with one, some, or all of the previous aspects, each of the first and second biasing members includes a hydraulic spring coupled to a control circuit of the at least one control module.

In another aspect combinable with one, some, or all of the previous aspects, the control circuit includes a linear motion potentiometer.

In another aspect combinable with one, some, or all of the previous aspects, the linear motion potentiometer is configured to output the signal representative of the detected movement to generate a profile of the wellbore relative to wellbore depth, the signal including a voltage signal.

In another aspect combinable with one, some, or all of the previous aspects, the first spherical member and the second spherical member are radially offset 180° in the tubular housing.

In another aspect combinable with one, some, or all of the previous aspects, the first spherical member and the second spherical member are axially and radially offset in the tubular housing.

In another aspect combinable with one, some, or all of the previous aspects, the at least one control module includes a first control module coupled to the first spherical member and configured to perform operations including adjusting the first spherical member from the retracted position to the extended position; detecting movement of the first spherical member between the extended and retracted positions in response to contact between the surface of the wellbore and the first spherical member during the drilling operation; and outputting a first signal representative of the detected movement of the first spherical member to generate a portion of the profile of the wellbore relative to wellbore depth.

In another aspect combinable with one, some, or all of the previous aspects, the at least one control module includes a second control module coupled to the second spherical member and configured to perform operations including adjusting the second spherical member from the retracted position to the extended position; detecting movement of the second spherical member between the extended and retracted positions in response to contact between the surface of the wellbore and the second spherical member during the drilling operation; and outputting a second signal representative of the detected movement of the second spherical member to generate a portion of the profile of the wellbore relative to wellbore depth.

In another aspect combinable with one, some, or all of the previous aspects, the wellbore includes an open hole completion, and the surface of the wellbore includes the subterranean formation.

In another example implementation, a method of generating a wellbore profile includes operating a drilling assembly to form a wellbore that extends from a terranean surface to a subterranean formation in a drilling operation, where the drilling assembly includes a bottom hole assembly that includes a downhole tool. The downhole tool includes a tubular housing; a first spherical member coupled to the tubular housing; a second spherical member coupled to the tubular housing radially offset from the first spherical member; and at least one control module. The method includes adjusting, with the at least one control module, the first and second spherical members from a retracted position within the tubular housing to an extended position protruding from the tubular housing to contact the wellbore during the drilling operation; detecting, with the at least one control module, movement of each of the first and second spherical members between the extended and retracted positions in response to contact between a surface of the wellbore and the first and second spherical members during the drilling operation; and outputting, with the at least one control module, a signal representative of the detected movement to generate a profile of the wellbore relative to wellbore depth.

An aspect combinable with the example implementation includes in response to a fluid signal provided to the at least one control module during the drilling operation, urging the first spherical member from the retracted position to the extended position with a first biasing member coupled between the first spherical member and the at least one control module.

Another aspect combinable with one, some, or all of the previous aspects includes in response to the fluid signal provided to the at least one control module during the drilling operation, urging the second spherical member from the retracted position to the extended position with a second biasing member coupled between the second spherical member and the at least one control module.

In another aspect combinable with one, some, or all of the previous aspects, urging the first spherical member from the retracted position to the extended position with the first biasing member includes releasing a first hydraulic spring from compression to urge the first spherical member from the retracted position to the extended position.

In another aspect combinable with one, some, or all of the previous aspects, urging the second spherical member from the retracted position to the extended position with the second biasing member includes releasing a second hydraulic spring from compression to urge the second spherical member from the retracted position to the extended position.

In another aspect combinable with one, some, or all of the previous aspects, outputting the signal representative of the detected movement to generate the profile of the wellbore relative to wellbore depth includes outputting an electrical signal from a linear motion potentiometer that converts the detected movement to the electrical signal; and converting the electrical signal to a mud pulse signal to send to the terranean surface.

In another aspect combinable with one, some, or all of the previous aspects, the electrical signal includes a voltage signal.

In another aspect combinable with one, some, or all of the previous aspects, the first spherical member and the second spherical member are radially offset 180° in the tubular housing.

In another aspect combinable with one, some, or all of the previous aspects, the first spherical member and the second spherical member are axially and radially offset in the tubular housing.

In another aspect combinable with one, some, or all of the previous aspects, the at least one control module includes a first control module coupled to the first spherical member, and the method includes adjusting, with the first control module, the first spherical member from the retracted position to the extended position; detecting, with the first control module, movement of the first spherical member between the extended and retracted positions in response to contact between the surface of the wellbore and the first spherical member during the drilling operation; and outputting, with the first control module, a first signal representative of the detected movement of the first spherical member to generate a portion of the profile of the wellbore relative to wellbore depth.

In another aspect combinable with one, some, or all of the previous aspects, the at least one control module includes a second control module coupled to the second spherical member, and the method includes adjusting, with the second control module, the second spherical member from the retracted position to the extended position; detecting, with the second control module, movement of the second spherical member between the extended and retracted positions in response to contact between the surface of the wellbore and the second spherical member during the drilling operation; and outputting, with the second control module, a second signal representative of the detected movement of the second spherical member to generate a portion of the profile of the wellbore relative to wellbore depth.

In another aspect combinable with one, some, or all of the previous aspects, the wellbore includes an open hole completion, and the surface of the wellbore includes the subterranean formation.

In another example implementation, a bottom hole assembly (BHA) includes a drill bit; and a tool sub-assembly. The tool sub-assembly includes a housing; a pair of trackballs coupled to the tubular housing and adjustable between a retracted position within the housing and an extended position protruding from the housing to contact a wellbore during a drilling operation; and at least one control module configured adjust the pair of trackballs from the retracted position to the extended position to contact the wellbore during the drilling operation and, in response to the contact, detect movement of the pair of trackballs between the extended and retracted positions.

An aspect combinable with the example implementation includes a first hydraulic spring coupled between a first trackball of the pair of trackballs and the at least one control module and configured to urge the first trackball from the retracted position to the extended position in response to a fluid signal provided to the at least one control module during the drilling operation.

Another aspect combinable with one, some, or all of the previous aspects includes a second hydraulic spring coupled between a second trackball of the pair of trackballs and the at least one control module and configured to urge the second trackball from the retracted position to the extended position in response to the fluid signal provided to the at least one control module during the drilling operation.

In another aspect combinable with one, some, or all of the previous aspects, the first trackball and the second trackball are radially offset in the housing.

In another aspect combinable with one, some, or all of the previous aspects, the first trackball and the second trackball are axially offset in the housing.

In another aspect combinable with one, some, or all of the previous aspects, the at least one control module is configured to generate a wellbore profile of the wellbore based on the detected movement of the pair of trackballs between the extended and retracted positions.

Implementations of a systems and methods for logging a wellbore profile according to the present disclosure may include one or more of the following features. For example, implementations according to the present disclosure can obtain physical direct measurements of a wellbore while drilling in real-time (with such measurements or other data storable for subsequent review). As another example, implementations according to the present disclosure can provide actual wellbore or borehole profile measurements through direct contact with a wall of a wellbore (e.g., an open hole completion) or an inner surface of a wellbore tubular while drilling.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example wellbore drilling system operable to measure at least one of a size or profile of a wellbore according to the present disclosure.

FIGS. 2A and 2B is a schematic diagram of an example implementation of a downhole tool operable to measure at least one of a size or profile of a wellbore during a drilling operation according to the present disclosure.

FIGS. 3A and 3B is a schematic diagram of another example implementation of a downhole tool operable to measure at least one of a size or profile of a wellbore during a drilling operation according to the present disclosure.

FIG. 4 is a schematic diagram of an example implementation of a portion of a control circuit for a downhole tool operable to measure at least one of a size or profile of a wellbore during a drilling operation according to the present disclosure.

FIG. 5 is a schematic diagram of radial cross-section of a downhole tool operable to measure at least one of a size or profile of a wellbore during a drilling operation according to the present disclosure.

FIG. 6 is a flowchart that describes an example method of generating a wellbore profile according to the present disclosure.

### DETAILED DESCRIPTION

The present disclosure describes implementations of systems and methods for measuring at least one of a size or profile of a wellbore (e.g., open hole or cased or otherwise). Example implementations according to the present disclosure include a downhole tool that can be coupled to or within a downhole drilling string, such as to or within a bottom hole assembly (BHA) that includes a drill bit. The downhole tool according to the present disclosure includes one or more biased spherical members mounted in a tubular (or other) housing that enable real-time wellbore profiling and size measurement while drilling. In some aspects, the one or more biased spherical members (also called trackballs) can be that deployed out of the tubular housing, which can be part of the BHA stabilizers. During drilling a wellbore, the one or more trackballs can contact a wellbore formation (in an open hole) or wellbore tubular without damage or sticking. In some aspects, the one or more trackballs are biased to retract into and extend from the tubular housing freely through one or more biasing members (e.g., hydraulic springs) within the tubular housing (e.g., the BHA stabilizers) to minimize friction and prevent sticking issues in the wellbore. For example, a spherical member or trackball have a rounded outer surface that reduces friction when in contact with the wellbore wall or casing.

In example aspects, systems and methods according to the present disclosure are operable to generate an azimuthal profile of the wellbore by capturing measurements from all angles of the hole and obtain real-time measurements of the wellbore diameter using a potentiometer-based system. The disclosed example implementations can provide advantages over conventional wireline logging methods, including direct measurement of borehole diameter in real-time while drilling, elimination of petrophysical interpretation uncertainties, reduction of time and costs associated with separate mechanical caliper runs, compatibility with various applications including logging and reaming operations, and provision of real-time geomechanics of the hole, aiding drilling operations and improving understanding of the reservoir matrix. Further, example implementations can enable real-time lower completion design while drilling and optimizing real-time reaming jobs.

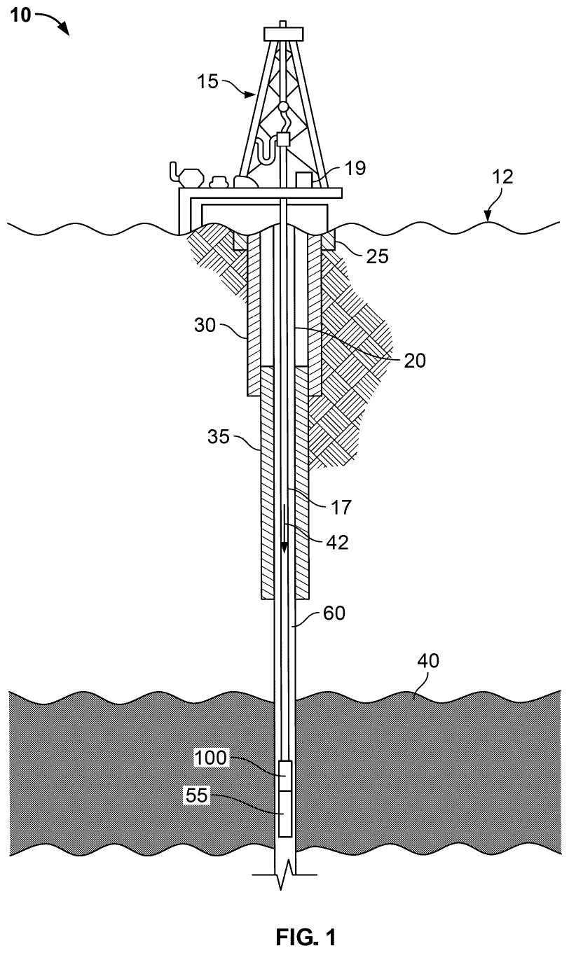

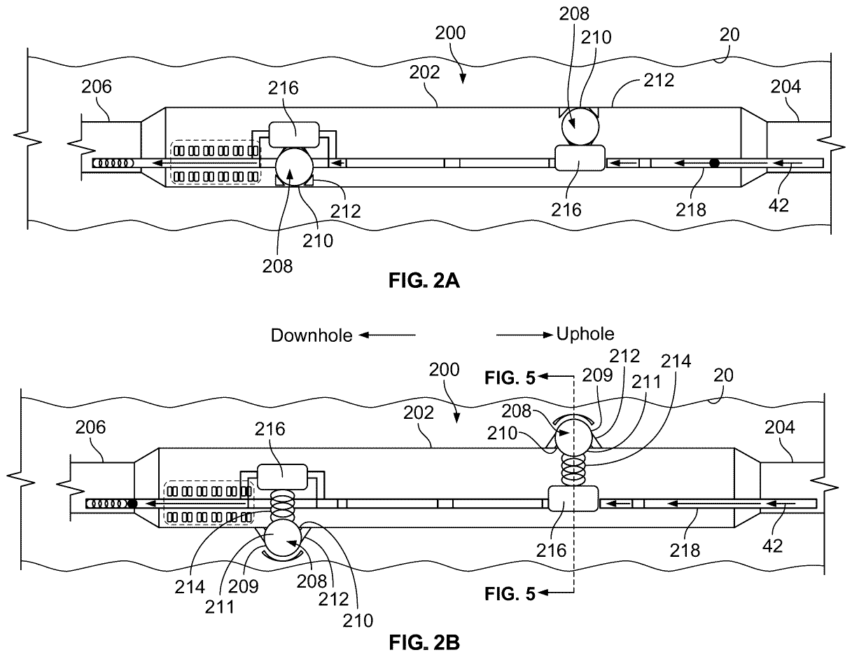

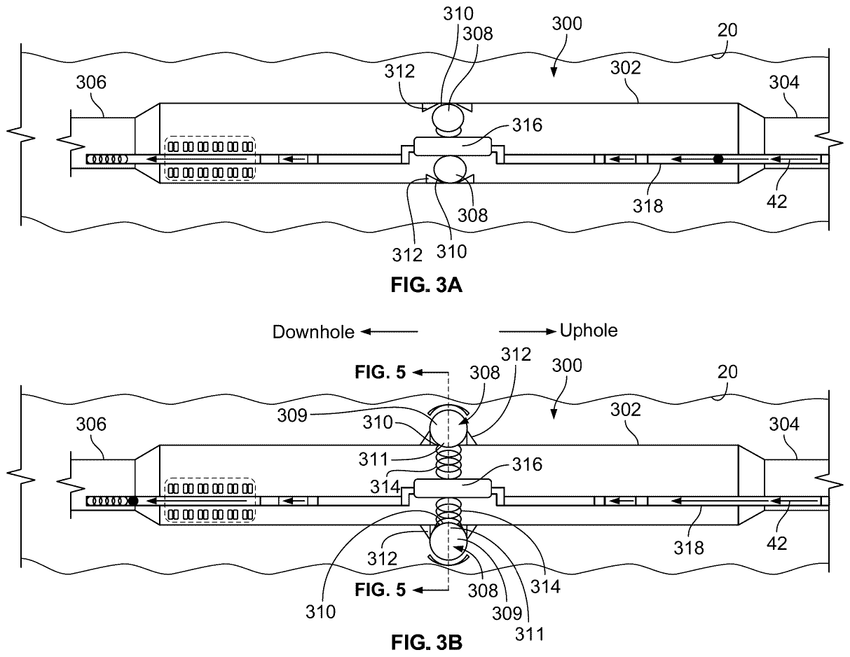

FIG. 1 is a schematic diagram of an example wellbore system 10 that operates to measure at least one of a size or profile of a wellbore 20 with a downhole tool 100 that is part of a BHA 55 according to the present disclosure. As shown, the wellbore system 10 accesses a subterranean formation 40, and provides access to hydrocarbons located in such subterranean formation 40, also called reservoir 40. In an example implementation of system 10, the system 10 may be used for a drilling operation as well as to measure a size or profile (or both) of the wellbore with an example implementation of the downhole tool 100 (also described in more detail in FIGS. 2A and 2B and FIGS. 3A and 3B). As illustrated in FIG. 1, an implementation of the wellbore system 10 includes a drilling assembly 15 deployed on a terranean surface 12. The drilling assembly 15 can be used to form the wellbore 20 extending from the terranean surface 12 and through one or more geological formations in the Earth. One or more subterranean formations, such as subterranean zone 40, are located under the terranean surface 12. One or more wellbore casings, such as a surface casing 30 and intermediate casing 35, may be installed in at least a portion of the wellbore 20 (for example subsequent to completion of the drilling operation or some other time).

In some embodiments, the drilling assembly 15 may be deployed on a body of water rather than the terranean surface 12. For instance, in some embodiments, the terranean surface 12 may be an ocean, gulf, sea, or any other body of water under which hydrocarbon-bearing formations may be found. In short, reference to the terranean surface 12 includes both land and water surfaces and contemplates forming and developing one or more wellbore systems 10 from either or both locations.

Generally, as a drilling system, the drilling assembly 15 may be any appropriate assembly or drilling rig used to form wellbores or boreholes in the Earth. The drilling assembly 15 may use traditional techniques to form such wellbores, such as the wellbore 20, or may use nontraditional or novel techniques. In some embodiments, the drilling assembly 15 may use rotary drilling equipment to form such wellbores. Rotary drilling equipment is known and may consist of a drill string 17 and the BHA 55 that includes a drill bit. In some embodiments, the drilling assembly 15 may consist of a rotary drilling rig. Rotating equipment on such a rotary drilling rig may consist of components that serve to rotate a drill bit, which in turn forms a wellbore, such as the wellbore 20, deeper and deeper into the ground. Rotating equipment consists of a number of components (not all shown here), which contribute to transferring power from a prime mover to the drill bit itself. The prime mover supplies power to a rotary table, or top direct drive system, which in turn supplies rotational power to the drill string 17. The drill string 17 is typically attached to the BHA 55 (with a drill bit). A swivel, which is attached to hoisting equipment, carries much, if not all of, the weight of the drill string 17, but may allow it to rotate freely.

The drill string 17 typically consists of sections of heavy steel pipe, which are threaded so that they can interlock together. Below the drill pipe are one or more drill collars, which are heavier, thicker, and stronger than the drill pipe. The threaded drill collars help to add weight to the drill string 17 above the drill bit to ensure that there is enough downward force on the drill bit of the BHA 55 to allow the bit to drill through the one or more geological formations. The number and nature of the drill collars on any particular rotary rig may be altered depending on the downhole conditions experienced while drilling.

The circulating system of a rotary drilling operation, such as the drilling assembly 15, may be an additional component of the drilling assembly 15. Generally, the circulating system may cool and lubricate the drill bit, removing the cuttings from the drill bit and the wellbore 20 (for example, through an annulus 60), and coat the walls of the wellbore 20 with a mud type cake. The circulating system can also keep a downhole borehole pressure controlled and send commands to downhole tools (such as downhole tool 100) through mud telemetry. The circulating system consists of drilling fluid 42, which is circulated down through the wellbore throughout the drilling process. Typically, the components of the circulating system include drilling fluid pumps, compressors, related plumbing fixtures, and specialty injectors for the addition of additives to the drilling fluid 42. In some embodiments, such as, for example, during a horizontal or directional drilling process, downhole motors may be used in conjunction with or in the drill bit of the BHA 55. Such a downhole motor may be a mud motor with a turbine arrangement, or a progressive cavity arrangement, such as a Moineau motor. These motors receive the drilling fluid 42 through the drill string 17 and rotate to drive the drill bit or change directions in the drilling operation.

In many rotary drilling operations, the drilling fluid 42 is pumped down the drill string 17 and out through ports or jets in the drill bit. The fluid then flows up toward the surface 12 within annulus 60 between the wellbore 20 and the drill string 17, carrying cuttings in suspension to the surface. The drilling fluid 42, much like the drill bit, may be chosen depending on the type of geological conditions found under subterranean surface 12.

In some embodiments of the wellbore system 10, the wellbore 20 may be cased with one or more casings. As illustrated, the wellbore 20 includes a conductor casing 25, which extends from the terranean surface 12 shortly into the Earth. A portion of the wellbore 20 enclosed by the conductor casing 25 may be a large diameter borehole. Additionally, in some embodiments, the wellbore 20 may be offset from vertical (for example, a slant wellbore). Even further, in some embodiments, the wellbore 20 may be a stepped wellbore, such that a portion is drilled vertically downward and then curved to a substantially horizontal wellbore portion. Additional substantially vertical and horizontal wellbore portions may be added according to, for example, the type of terranean surface 12, the depth of one or more target subterranean formations, the depth of one or more productive subterranean formations, or other criteria.

Downhole of the conductor casing 25 may be the surface casing 30. The surface casing 30 may enclose a slightly smaller borehole and protect the wellbore 20 from intrusion of, for example, freshwater aquifers located near the terranean surface 12. The wellbore 20 may than extend vertically downward. This portion of the wellbore 20 may be enclosed by the intermediate casing 35.

In some aspects, the drilling assembly 15 (or other portion of the well system 10) may include a control system 19, for example, microprocessor-based, electro-mechanical, or otherwise, that may control the drill bit of the BHA 55. In some aspects, the control system 19 may control one or more pumps, one or more valves, as well as other equipment that is part of or connected to the drilling fluid circulation system. For example, the control system 19 may control a flow rate, pressure, or other circulation criteria of the drilling fluid 42. In some aspects, the control system 19 may also control a composition of the drilling fluid 42 such as, a water percentage of the fluid, or an additive that may be mixed with the drilling fluid 42.

FIGS. 2A and 2B is a schematic diagram of an example implementation of a downhole tool 200 operable to measure at least one of a size or profile of a wellbore during a drilling operation according to the present disclosure. Downhole tool 200 can be used as the downhole tool 100 in FIG. 1. FIG. 2A shows the downhole tool 200 in a retracted (or run in) position in which spherical members 208 are completely or substantially retracted within a housing 202 of the tool 200. FIG. 2B shows the downhole tool 200 in an extended (or operating) position in which at least a portion of each of the spherical members 208 is extended from the housing 202 of the tool 200 to contact the wellbore 20.

As shown in these figures, downhole tool 200 includes the housing 202, which includes a top sub-assembly 204 and a bottom sub-assembly 206. In some aspects, the top sub-assembly 204 and bottom sub-assembly 206 allow the downhole tool 200 to be coupled (for example, threadingly or otherwise) within or to a BHA, a drilling string, or other downhole conveyance. In some aspects, the downhole tool 200 can be a separate collar assembly that is combined operationally with the BHA in a measurement-while-drilling (MWD) or logging-while-drilling (LWD) downhole assembly that is coupled to a downhole conveyance (for example, drill string).

In this example, there are two spherical members 208 (or trackballs 208) that are positioned in the housing 202. Alternative implementations can have more or fewer spherical members 208, including one spherical member 208. In the retracted position of FIG. 2A, the spherical members 208 are completely or substantially stored within the housing 202. A seal 212 seals an opening 210 through which the spherical member 208 can extend in the extended position of FIG. 2B. The seal 212, in some aspects, can be a T-seal or lip seal that resists a high-pressure differential across the opening 210, thereby preventing or reducing fluid (for example, drilling mud returning to the surface) from entering the housing 202 through the opening 210 when the spherical member 208 is in the retracted position or the extended position.

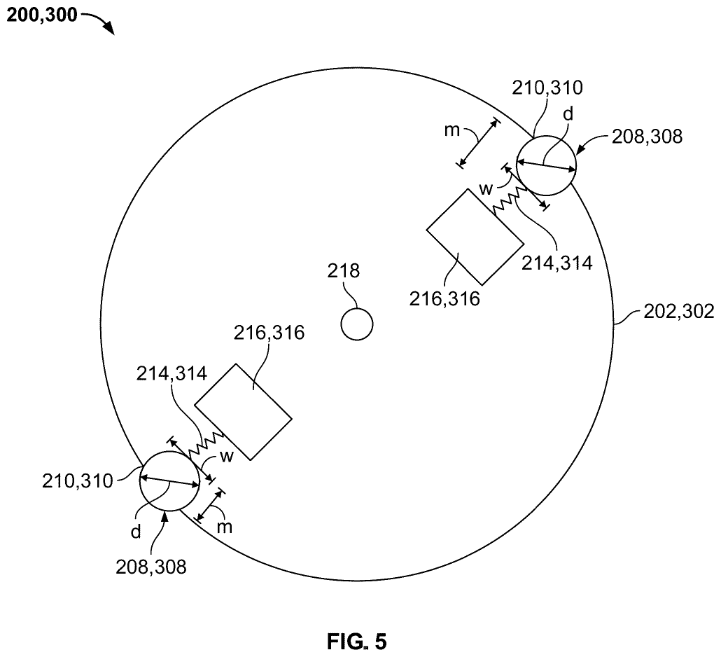

In some aspects, the spherical members 208 are free to rotate in the extended position as shown in FIG. 2B when in contact with the wellbore 20. The spherical members 208 can be made of, for example, tungsten carbide or other hardened material, which can withstand the harsh downhole drilling environment in the wellbore 20. Turning to FIG. 5, this figure shows a cross-section taken through the downhole tool 200 in FIG. 2A with the tool 200 in the extended (or operating) position.

As shown in this figure, the spherical members 208 are radially offset at or about 180° apart from each other on the housing 202; as shown in FIGS. 2A and 2B, the spherical members 208 are axially offset from each other along a length of the housing 202. The example implementation of the downhole tool 200 can be used, for example, in tool strings of a size of 4¾″ used to drill a borehole of between 5⅞″ and 6⅕″.

In this example implementation, a diameter, d, of the spherical members 208 can be larger than a width, w, of the opening 210. The opening 210 can also be circular and formed as an aperture on the housing 202 for each spherical member 208. Thus, even in the extended position of FIG. 2B, the spherical members 208 cannot be removed from the housing 202 through the openings 210 (for example, such as due to contact between the spherical members 208 and the wellbore 20 or a wellbore tubular).

As shown in FIG. 2B, in the extended position an exposed portion 209 of the spherical member 208 extends from the housing 202 (for example, about 2″) while an inset portion 211 of the spherical member 208 remains enclosed within the housing 202. In some aspects, the exposed portion 209 can be smaller in volume than the inset portion 211. In some aspects, the exposed portion 209 can be almost equal in volume to the inset portion 211.

Turning to FIGS. 2A and 2B, in the example implementation of the downhole tool 200, a fluid conduit 218 extends through the downhole tool 200 and is fluidly coupled to the drilling mud system so that drilling mud 42 passes through the downhole tool 200 during a drilling operation. As shown in this example, a control module 216 is fluidly coupled to the fluid conduit 218 to receive mud pulses through drilling mud 42. The control module 216, in this example, includes both hydraulic and electrical control elements to control a biasing member 214 positioned to adjust the spherical member 208 from the retracted position to the extended position. Each control module 216 can also record movement, M (see FIG. 5), of a respective spherical member 208 relative to the housing 202 during travel through the wellbore 20 and due to contact between the spherical member 208 and wellbore 20 as described herein.

For example, each control module 216 can receive a flow of the drilling fluid 42, which, in the retracted position, releases a hydraulic holding power that compresses the biasing member 214 (for example, as a hydraulic spring). Such hydraulic holding power compresses the spherical members 212 once running in the wellbore 20. This hydraulic holding power is then released through a mud pulse command to the downhole tool 200 to push the spherical members 212 out of the housing 202. Another mud pulse can return the hydraulic holding power to hold the spherical members 212 in the retracted position.

In compression, the biasing members 214, which are coupled to the spherical members 208, can maintain the spherical members 208 in the retracted position of FIG. 2A (during a run in or non-active operation). Upon, for example, a particular drilling mud pulse sequence, the control modules 216 can release the hydraulic pressure, thereby causing the biasing members 214 to decompress to push the spherical members 208 out of the openings 210 and into the extended position as shown in FIG. 2B. In the extended position, the spherical members 208 can contact the wellbore 20 during a drilling or other active operation in order to measure a size or profile of the wellbore 20.

For example, during a drilling or other active operation, contact between the wellbore 20 and the spherical members 208 can cause the spherical members 208 to move (M) into and out of the openings 210, which in turn causes changes in tension or compression of the biasing members 214. With such changes, the electrical portion of the control modules 216 can measure this movement, M. For example, the electrical portion of the control modules 216 can be a potentiometer and, more particularly, a linear motion potentiometer (LMP). During operation of the downhole tool 200 in the extended position of FIG. 2B, the movement, M, is converted to a voltage (or change in voltage) by the LMP. The voltage signal (which represents an amplitude or amount of movement, M) can be transmitted to the terranean surface in the form of mud pulse telemetry.

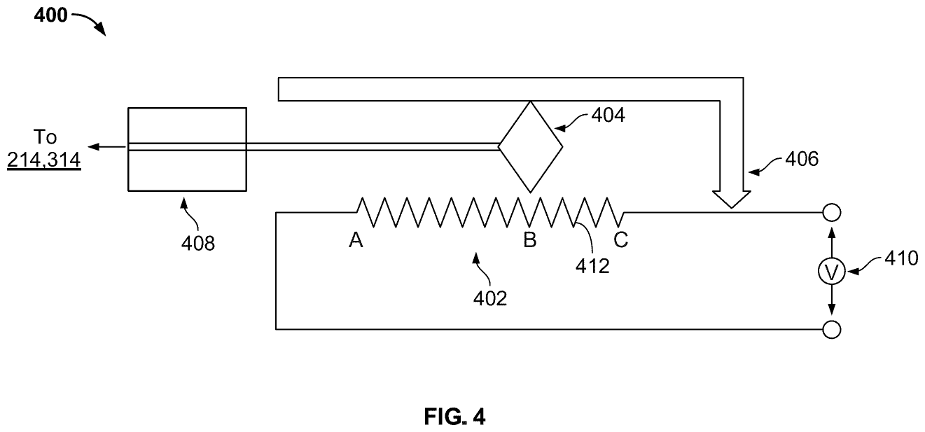

Turning to FIG. 4, this figure is a schematic diagram of an example implementation of an electrical circuit 400 of the control module 216 according to the present disclosure. Electrical circuit 400, or LMP 400, comprises an electrical circuit that can convert compression and expansion of the biasing member 214 (that reflects the movement, M) to a voltage signal. As shown in this example, the LMP 400 includes a force summing module 408 which is coupled to a slider 404 that slides, based on the movement, M, along a potentiometer 402. The movement, M, of the spherical members 208 is translated to extension or compression of the biasing member 214 as measured by the force summing module 408. The slider 404 moves along a linear resistive element 412 that acts as a variable resistor. The proportional change in resistance is used to indicate the change in length of the biasing member 214, which is measured (relative to ground 406) as a voltage difference output 410.

During a drilling operation with the downhole tool 200 in the extended position, the spherical members 208 contact the wellbore 20 and are moved (through such contact) with movement, M, which changes the tension and compression of the biasing members 214. The control modules 216 use the LMP 400 to convert this movement, M, to a voltage output 410, which in turn is transmitted to the terranean surface (for example, to control system 19) as mud telemetry pulses. In turn, the control system 19 can generate a profile or dimension (for example, diameter) relative to depth of the wellbore 20.

FIGS. 3A and 3B is a schematic diagram of another example implementation of a downhole tool operable to measure at least one of a size or profile of a wellbore during a drilling operation according to the present disclosure. Downhole tool 300 can be used as the downhole tool 100 in FIG. 1. FIG. 3A shows the downhole tool 300 in a retracted (or run in) position in which spherical members 308 are completely or substantially retracted within a housing 302 of the tool 300. FIG. 3B shows the downhole tool 300 in an extended (or operating) position in which at least a portion of each of the spherical members 308 is extended from the housing 302 of the tool 300 to contact the wellbore 20.

As shown in these figures, downhole tool 300 includes the housing 302, which includes a top sub-assembly 304 and a bottom sub-assembly 306. In some aspects, the top sub-assembly 304 and bottom sub-assembly 306 allow the downhole tool 300 to be coupled (for example, threadingly or otherwise) within or to a BHA, a drilling string, or other downhole conveyance. In some aspects, the downhole tool 300 can be a separate collar assembly that is combined operationally with the BHA in a measurement-while-drilling (MWD) or logging-while-drilling (LWD) downhole assembly that is coupled to a downhole conveyance (for example, drill string).

In this example, there are two spherical members 308 (or trackballs 308) that are positioned in the housing 302. Alternative implementations can have more or fewer spherical members 308, including one spherical member 308. In the retracted position of FIG. 3A, the spherical members 308 are completely or substantially stored within the housing 302. A seal 312 seals an opening 310 through which the spherical member 308 can extend in the extended position of FIG. 3B. The seal 312, in some aspects, can be a T-seal or lip seal that resists a high-pressure differential across the opening 310, thereby preventing or reducing fluid (for example, drilling mud returning to the surface) from entering the housing 302 through the opening 310 when the spherical member 308 is in the retracted position or the extended position.

In some aspects, the spherical members 308 are free to rotate in the extended position as shown in FIG. 3B when in contact with the wellbore 20. The spherical members 308 can be made of, for example, tungsten carbide or other hardened material, which can withstand the harsh downhole drilling environment in the wellbore 20. Turning to FIG. 5, this figure shows a cross-section taken through the downhole tool 300 in FIG. 3A with the tool 300 in the extended (or operating) position.

As shown in this figure, the spherical members 308 are radially offset at or about 180° apart from each other on the housing 302; as shown in FIGS. 3A and 3B, the spherical members 308 are positioned axially at a particular location between the top sub-assembly 304 and the bottom sub-assembly 306. The example implementation of the downhole tool 300 can be used, for example, in tool strings of a size of 6¾″ used to drill a borehole of between 8⅜″ and 8½″.

In this example implementation, a diameter, d, of the spherical members 308 can be larger than a width, w, of the opening 310. The opening 310 can also be circular and formed as an aperture on the housing 302 for each spherical member 308. Thus, even in the extended position of FIG. 3B, the spherical members 308 cannot be removed from the housing 302 through the openings 310 (for example, such as due to contact between the spherical members 308 and the wellbore 20 or a wellbore tubular).

As shown in FIG. 3B, in the extended position an exposed portion 309 of the spherical member 308 extends from the housing 302 (for example, about 2″) while an inset portion 311 of the spherical member 308 remains enclosed within the housing 302. In some aspects, the exposed portion 309 can be smaller in volume than the inset portion 311. In some aspects, the exposed portion 309 can be almost equal in volume to the inset portion 311.

Turning to FIGS. 3A and 3B, in the example implementation of the downhole tool 300, a fluid conduit 318 extends through the downhole tool 300 and is fluidly coupled to the drilling mud system so that drilling mud 42 passes through the downhole tool 300 during a drilling operation. As shown in this example, a control module 316 is fluidly coupled to the fluid conduit 318 to receive mud pulses through drilling mud 42. The control module 316, in this example, includes both hydraulic and electrical control elements to control a biasing member 314 positioned to adjust the spherical member 308 from the retracted position to the extended position. Each control module 316 can also record movement, M (see FIG. 5), of a respective spherical member 308 relative to the housing 302 during travel through the wellbore 20 and due to contact between the spherical member 308 and wellbore 20 as described herein.

For example, each control module 316 can receive a flow of the drilling fluid 42, which, in the retracted position, releases a hydraulic holding power that compresses the biasing member 314 (for example, as a hydraulic spring). Such hydraulic holding power compresses the spherical members 312 once running in the wellbore 20. This hydraulic holding power is then released through a mud pulse command to the downhole tool 300 to push the spherical members 312 out of the housing 302. Another mud pulse can return the hydraulic holding power to hold the spherical members 312 in the retracted position.

In compression, the biasing members 314, which are coupled to the spherical members 308, can maintain the spherical members 308 in the retracted position of FIG. 3A (during a run in or non-active operation). Upon, for example, a particular drilling mud pulse sequence, the control modules 316 can release the hydraulic pressure, thereby causing the biasing members 314 to decompress to push the spherical members 308 out of the openings 310 and into the extended position as shown in FIG. 3B. In the extended position, the spherical members 308 can contact the wellbore 20 during a drilling or other active operation in order to measure a size or profile of the wellbore 20.

For example, during a drilling or other active operation, contact between the wellbore 20 and the spherical members 308 can cause the spherical members 308 to move (M) into and out of the openings 310, which in turn causes changes in tension or compression of the biasing members 314. With such changes, the electrical portion of the control modules 316 can measure this movement, M. For example, the electrical portion of the control modules 316 can be a potentiometer and, more particularly, a linear motion potentiometer (LMP). During operation of the downhole tool 300 in the extended position of FIG. 3B, the movement, M, is converted to a voltage (or change in voltage) by the LMP. The voltage signal (which represents an amplitude or amount of movement, M) can be transmitted to the terranean surface in the form of mud pulse telemetry.

Turning back to FIG. 4, this figure is a schematic diagram of an example implementation of an electrical circuit 400 of the control module 316 according to the present disclosure. Electrical circuit 400, or LMP 400, comprises an electrical circuit that can convert compression and expansion of the biasing member 314 (that reflects the movement, M) to a voltage signal. As shown in this example, the LMP 400 includes a force summing module 408 which is coupled to a slider 404 that slides, based on the movement, M, along a potentiometer 402. The movement, M, of the spherical members 308 is translated to extension or compression of the biasing member 314 as measured by the force summing module 408. The slider 404 moves along a linear resistive element 412 that acts as a variable resistor. The proportional change in resistance is used to indicate the change in length of the biasing member 314, which is measured (relative to ground 406) as a voltage difference output 410.

During a drilling operation with the downhole tool 300 in the extended position, the spherical members 308 contact the wellbore 20 and are moved (through such contact) with movement, M, which changes the tension and compression of the biasing members 314. The control modules 316 use the LMP 400 to convert this movement, M, to a voltage output 410, which in turn is transmitted to the terranean surface (for example, to control system 19) as mud telemetry pulses. In turn, the control system 19 can generate a profile or dimension (for example, diameter) relative to depth of the wellbore 20.

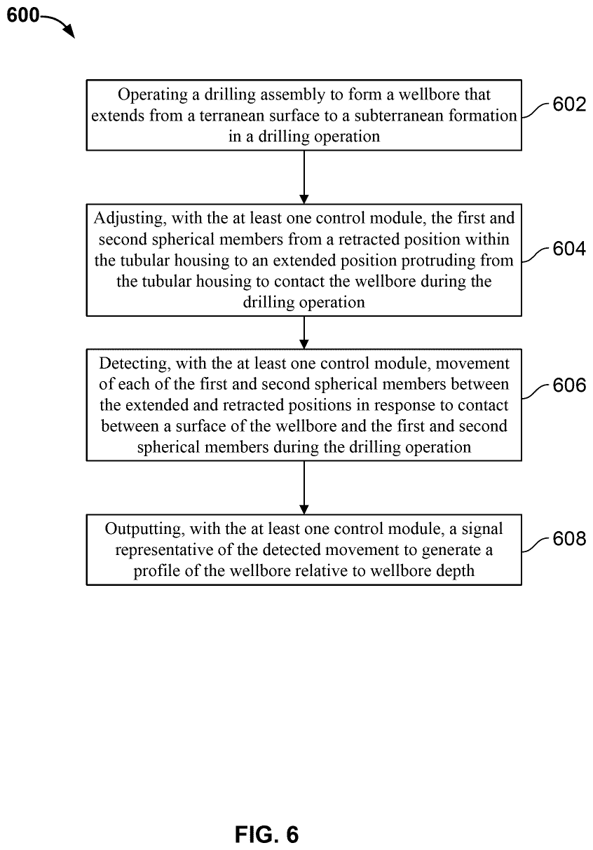

FIG. 6 is a flowchart that describes an example method 600 of generating a wellbore profile according to the present disclosure. Method 600 can begin at step 602, which includes operating a drilling assembly to form a wellbore that extends from a terranean surface to a subterranean formation in a drilling operation. In some aspects, the drilling assembly can be drilling assembly 55 that includes downhole tool 100, 200, or 300. For example, the downhole tool 200 includes a tubular housing 202; a first spherical member 210 coupled to the tubular housing 202; a second spherical member 210 coupled to the tubular housing 202 and radially offset from the first spherical member 210; and at least one control module 216. Method 600 can continue at step 604, which includes adjusting, with the at least one control module, the first and second spherical members from a retracted position within the tubular housing to an extended position protruding from the tubular housing to contact the wellbore during the drilling operation. For example, control module(s) 216 can utilize a hydraulic signal, an electric signal, a combination thereof, or other signal type (for example, mechanical) to adjust spherical members 210 to extend from tubular housing 202. Method 600 can continue at step 606, which includes detecting, with the at least one control module, movement of each of the first and second spherical members between the extended and retracted positions in response to contact between a surface of the wellbore and the first and second spherical members during the drilling operation. For example, the control module(s) 216 can utilize, for instance, an electric potentiometer communicably coupled to the spherical members 210 to measure an amount of movement (for example, into and out of the tubular housing 202) of the spherical members 210 in response to contact with the wall of the wellbore 20 (or interior surface of a wellbore tubular). Method 600 can continue at step 608, which includes outputting, with the at least one control module, a signal representative of the detected movement to generate a profile of the wellbore relative to wellbore depth. In some aspects, the signal can be a mud pulse telemetry signal.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

1. A downhole tool, comprising:
a tubular housing comprising a top sub-assembly configured to couple to or within a bottom hole assembly of a drilling assembly, the drilling assembly configured to form a wellbore that extends from a terranean surface to a subterranean formation in a drilling operation;
a first spherical member coupled to the tubular housing and adjustable between a retracted position within the tubular housing and an extended position protruding from the tubular housing to contact the wellbore during the drilling operation;
a second spherical member coupled to the tubular housing radially offset from the first spherical member and adjustable between a retracted position within the tubular housing and an extended position protruding from the tubular housing to contact the wellbore during the drilling operation; and
at least one control module configured to perform operations comprising:
adjusting each of the first and second spherical members from the retracted position to the extended position;
detecting movement of each of the first and second spherical members between the extended and retracted positions in response to contact between a surface of the wellbore and the first and second spherical members during the drilling operation; and
outputting a signal representative of the detected movement to generate a profile of the wellbore relative to wellbore depth;
a first biasing member coupled between the first spherical member and the at least one control module; and
a second biasing member coupled between the second spherical member and the at least one control module, each of the first and second biasing members configured to urge the respective first and second spherical members from the retracted position to the extended position in response to a fluid signal provided to the at least one control module during the drilling operation, each of the first and second biasing members comprising a hydraulic spring coupled to a control circuit of the at least one control module.

2. (canceled)

3. (canceled)

4. The downhole tool of claim 1, wherein the control circuit comprises a linear motion potentiometer.

5. The downhole tool of claim 4, wherein the linear motion potentiometer is configured to output the signal representative of the detected movement to generate a profile of the wellbore relative to wellbore depth, the signal comprising a voltage signal.

6. The downhole tool of claim 1, wherein the first spherical member and the second spherical member are radially offset 180° in the tubular housing.

7. The downhole tool of claim 1, wherein the first spherical member and the second spherical member are axially and radially offset in the tubular housing.

8. The downhole tool of claim 7, wherein the at least one control module comprises a first control module coupled to the first spherical member and configured to perform operations comprising:
adjusting the first spherical member from the retracted position to the extended position;
detecting movement of the first spherical member between the extended and retracted positions in response to contact between the surface of the wellbore and the first spherical member during the drilling operation; and
outputting a first signal representative of the detected movement of the first spherical member to generate a portion of the profile of the wellbore relative to wellbore depth.

9. The downhole tool of claim 8, wherein the at least one control module comprises a second control module coupled to the second spherical member and configured to perform operations comprising:
adjusting the second spherical member from the retracted position to the extended position;
detecting movement of the second spherical member between the extended and retracted positions in response to contact between the surface of the wellbore and the second spherical member during the drilling operation; and
outputting a second signal representative of the detected movement of the second spherical member to generate a portion of the profile of the wellbore relative to wellbore depth.

10. The downhole tool of claim 1, wherein the wellbore comprises an open hole completion, and the surface of the wellbore comprises the subterranean formation.

11-25. (canceled)

26. The downhole tool of claim 4, wherein the first spherical member and the second spherical member are radially offset 180° in the tubular housing.

27. The downhole tool of claim 26, wherein the first spherical member and the second spherical member are axially and radially offset in the tubular housing.

28. The downhole tool of claim 4, wherein the first spherical member and the second spherical member are axially and radially offset in the tubular housing.

29. The downhole tool of claim 4, wherein the wellbore comprises an open hole completion, and the surface of the wellbore comprises the subterranean formation.

30. A downhole tool, comprising:
a tubular housing comprising a top sub-assembly configured to couple to or within a bottom hole assembly of a drilling assembly, the drilling assembly configured to form a wellbore that extends from a terranean surface to a subterranean formation in a drilling operation;
a first spherical member coupled to the tubular housing and adjustable between a retracted position within the tubular housing and an extended position protruding from the tubular housing to contact the wellbore during the drilling operation;
a second spherical member coupled to the tubular housing radially offset from the first spherical member and adjustable between a retracted position within the tubular housing and an extended position protruding from the tubular housing to contact the wellbore during the drilling operation; and
at least one control module configured to perform operations, the at least one control module comprising a first control module coupled to the first spherical member and a second control module coupled to the second spherical member, the operations comprising:
adjusting, with the first control module, the first spherical member from the retracted position to the extended position;
adjusting, with the second control module, the second spherical member from the retracted position to the extended position;
detecting, with the first control module, movement of the first spherical member between the extended and retracted positions in response to contact between the surface of the wellbore and the first spherical member during the drilling operation;
detecting, with the second control module, movement of the second spherical member between the extended and retracted positions in response to contact between the surface of the wellbore and the second spherical member during the drilling operation;
outputting, with the first control module, a first signal representative of the detected movement of the first spherical member to generate a portion of the profile of the wellbore relative to wellbore depth; and
outputting, with the second control module, a second signal representative of the detected movement of the second spherical member to generate a portion of the profile of the wellbore relative to wellbore depth.

31. The downhole tool of claim 30, comprising a first biasing member coupled between the first spherical member and the at least one control module and a second biasing member coupled between the second spherical member and the at least one control module, each of the first and second biasing members configured to urge the respective first and second spherical members from the retracted position to the extended position in response to a fluid signal provided to the at least one control module during the drilling operation.

32. The downhole tool of claim 31, wherein each of the first and second biasing members comprises a hydraulic spring coupled to a control circuit of the at least one control module.

33. The downhole tool of claim 32, wherein the control circuit comprises a linear motion potentiometer.

34. The downhole tool of claim 33, wherein the linear motion potentiometer is configured to output the signal representative of the detected movement to generate a profile of the wellbore relative to wellbore depth, the signal comprising a voltage signal.

35. The downhole tool of claim 30, wherein the first spherical member and the second spherical member are radially offset 180° in the tubular housing.

36. The downhole tool of claim 30, wherein the first spherical member and the second spherical member are axially and radially offset in the tubular housing.

37. The downhole tool of claim 30, wherein the wellbore comprises an open hole completion, and the surface of the wellbore comprises the subterranean formation.

38. The downhole tool of claim 31, wherein each of the first and second control modules is configured to fluidly couple to a fluid conduit of the drilling assembly to receive one or more mud pulse commands through a drilling fluid circulated in the fluid conduit.

39. The downhole tool of claim 38, wherein at least one of the first or second control modules is configured to receive at least one of the one or more mud pulse commands to release a hydraulic holding power that compresses the respective first or second biasing member into the respective first or second spherical member.

40. The downhole tool of claim 38, wherein at least one of the first or second control modules is configured to receive at least one of the one or more mud pulse commands to maintain a hydraulic holding power that compresses the respective first or second biasing member into the respective first or second spherical member.

41. The downhole tool of claim 30, wherein each of the first and second control modules comprises hydraulic and electrical control elements.
